(19) United States
(12) Patent Application Publication
(10) Pub. No.: US 2008/0121210 A1
(43) Pub. Date: May 29, 2008

(54) Method for Controlling the Engine of a Vehicle by Valve Lift Laws

(75) Inventors: Jacky Guezet, Les Cresnays (FR); Sylvain Savy, Juvisy Sur Orge (FR); Laurent Krebs, Brignais (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT s.a.s, Boulogne Billancourt (FR)

(21) Appl. No.: 11/577,959

(22) PCT Filed: Oct. 25, 2005
(86) PCT No.: PCT/FR05/50897

§ 371 Date: Jul. 25, 2007

(30) Foreign Application Priority Data
Oct. 25, 2004 (FR) 0411342

(51) Int. Cl. F02D 13/02

(52) U.S. Cl. 123/345; 123/347

(57) ABSTRACT

A method and device for controlling the engine of a vehicle, wherein an opening movement is given to at least one admission valve in an exhaust phase while an opening movement is given to at least one exhaust valve associated with a same cylinder as the admission valve, and the two opening movements begin at a same time.

The invention relates to vehicle engines.

In vehicle internal combustion engines, it is conventional to implement an exhaust gas recirculation or EGR. This is the case, for example, in compression ignition diesel engines, for which, at certain operating points, the unburnt gases are recirculated. The use of EGR gases in increasingly large quantities in diesel engines helps significantly reduce the nitrogen oxides, or NOx, emitted into the atmosphere.

The recirculated exhaust gas temperature also has a strong influence on pollutant emissions, and more particularly on unburnts at low engine loads. In particular attempts are made to reduce the unburnt emissions at low loads. Thus, diesel engines increasingly often make use of an EGR gas cooling system in order to limit the NOx emissions. However, this cooling has the effect of increasing the emissions of unburnts at the low engine loads when the engine is cold and the oxidation catalyst is not initiated.

In order to limit the unburnt emissions a low load points or when the engine is cold, it is possible to provide a bypass of the recirculated exhaust gas heat exchanger This serves to have hotter EGR gases, which is favorable to the reduction of unburnt emissions. This solution, which is compatible with the Euro 4 standard, is however limited. The future Euro 5 (or Sulev) standard will be much more stringent in terms of emissions of smoke, NOx and unburnts. To achieve the targets on NOx emissions, it is planned n particular to introduce a much larger quantity of EGR gases into the engines, which will have the effect of sharply increasing emissions of unburnts. Under these conditions, the bypass of the ER gas cooler will no longer be sufficient to obtain the quantities of unburnt emissions at the engine exhaust compatible with the future Euro 5 standard.

It is an object of the invention to further improve engine performance with regard to pollution control standards.

For this purpose, the invention provides a method for controlling a vehicle engine, in which an opening movement is imparted to at least one intake valve while an opening movement is imparted to at least one exhaust valve associated with the same cylinder as the intake valve.

The inventive method may further have at least one of the following features

the two opening movements are initiated at the same time;

the opening movement of the exhaust valve is initiated after having initiated the opening movement of the intake valve;

the two opening movements have different amplitudes; and

a closure movement is imparted to the intake valve while a closure movement is imparted to the exhaust valve

The invention also provides for a method for controlling a vehicle engine in which a closure movement is imparted to at least one intake valve while a closure movement is imparted to at least one exhaust valve associated with the same cylinder as the intake valve.

The inventive method may further have at least one of the following features:

the closure movement of the intake valve is completed before completing the closure movement of the exhaust valve;

the two closure movements are initiated at the same time;

the two closure movements have different amplitudes; and

an opening movement is imparted to the intake valve while an opening movement is imparted to the exhaust valve.

These two methods may further have at least one of the following features

the exhaust valve is kept closed and during this period, the intake valve is opened then closed;

during an engine cycle, the intake valve is opened twice and the exhaust valve is opened once;

the two openings of the intake valve have different amplitudes;

the intake valve is kept closed and during this period the exhaust valve is opened then closed;

during an engine cycle, the exhaust valve is opened twice and the intake valve is opened once;

the two openings of the exhaust valve have different amplitudes;

it is only implemented when an engine load is lower than a predefined value; and

the engine is a direct injection diesel engine.

The invention also provides a vehicle engine comprising

at least one cylinder; and

intake and exhaust valves associated with the cylinder,

the engine comprising controlled means arranged to impart an opening movement to the intake valve while imparting an opening movement to the exhaust valve.

Finally, the invention provides a vehicle engine comprising:

at least one cylinder; and

intake and exhaust valves associated with the cylinder,

the engine comprising controlled means arranged to impart a closure movement to the intake valve while imparting a closure movement to the exhaust valve

Other features and advantages of the invention will further appear in the description below of two preferred embodiments of the invention provided as nonlimiting examples with reference to the drawings appended hereto in which:

FIG. 1 is a schematic view of an engine according to a preferred embodiment of the invention;

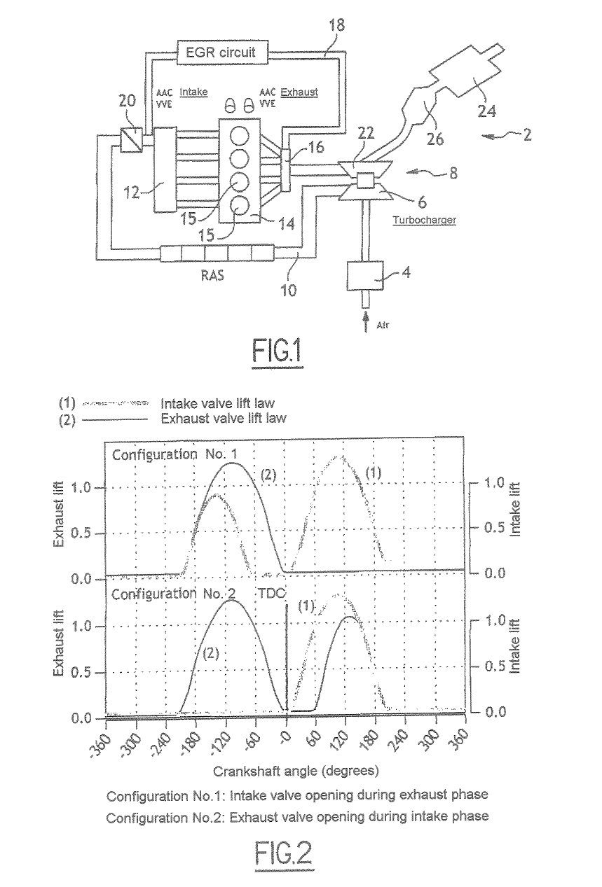

FIG. 2 shows the valve lift curves illustrating two exemplary embodiments of the inventive method;

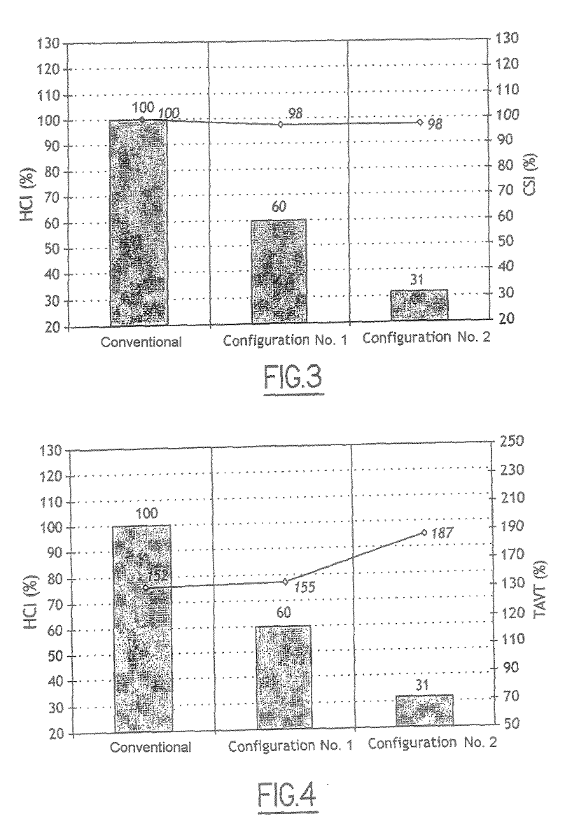

FIG. 3 is a diagram illustrating the comparative test results between an engine of the prior art and the two exemplary embodiments of FIG. 2 and showing, in the columns and on the Y-axis on the left, the emission of hydrocarbons, and on the curve and on the Y-axis on the right, the fuel consumption; and

FIG. 4 is a diagram similar to FIG. 3 showing the hydrocarbon emissions and the exhaust temperature.

FIG. 1 schematically shows an engine 2 according to a preferred embodiment of the invention. This engine comprises an air filter 4 communicating with a compressor 6 of a turbocharger 8. A line 10 indirectly communicates the compressor with an intake distributor 12 controlling the gas intake into the cylinders 15 arranged in a cylinder head 14 of the engine. Each cylinder contains a piston (not shown). Furthermore, each cylinder is associated with at least one intake valve and at least one exhaust valve, and preferably two of each. The movement of the exhaust valves is controlled by an exhaust distributor 16. The engine comprises an external circuit 18 for exhaust gas recirculation, withdrawing a fraction of the exhaust gases exiting the cylinder head to reinject them into the intake circuit upstream of the distributor 12. The quantity of exhaust gases recirculated by this circuit 18 can be controlled using a valve 20 in a manner known per se. The circuit 18 comprises in particular a cooler and a bypass thereof which are not shown. The fraction of exhaust gases not recirculated rotates a turbine 22 of the turbocharger 8 and is conveyed to an exhaust device 24 particularly comprising an oxidation catalyst 26.

At the operating points corresponding to the medium and high engine loads, the external EGR circuit 18 feeds the intake circuit with strongly cooled burnt gases. In fact, at these operating points, it is mainly the NOx emissions which must be reduced. Emissions of unburnts are relatively low and the oxidation catalyst is already initiated.

In this case, an attempt is made to increase the quantity of exhaust gases recirculated without excessively increasing fuel consumption at the engine operating points corresponding to the low loads or to those at which the engine is cold. For this purpose, the exhaust gases are internally recirculated without passing through the circuit 18 and, thanks to a suitable control of the intake and exhaust valves using the distributors 12 and 16.

Thus, to increase the quantity of internal EGR gases, the valve lift laws are modified thanks to the distributors 12 and 16.

Two preferred embodiments of the inventive method are now presented, each serving to increase the quantity of internal EGR.

With reference to FIG. 2, the first embodiment is that of configuration 1. In short, in addition to completing a normal engine cycle with regards to the valves, the intake valves are opened while the exhaust valves are opened for the exhaust.

The diagrams in FIG. 2 show on the X-axis the engine crankshaft angles and on the Y-axis the extension of each valve outside its housing

More precisely, in configuration 1, at the same time as the opening movement of the exhaust valves is initiated to remove the gases present in the cylinder (curve 2), the opening movement of the intake valves is initiated (curve 1). However, the two opening movements have different amplitudes, so that the amplitude of movement of the intake valves is lower than the amplitude of movement of the exhaust valves Since all the valves move at the same speed, and the closure movement of each of these valves begins after it has reached the specified open position, it follows that the closure movement of the intake valves is initiated whereas the opening movement of the exhaust valves is not yet complete. During the progress of the closure movement of the intake valves, the closure movement of the exhaust valves is initiated and continued. Finally, the closure movement of the intake valves is completed before completing the closure movement of the exhaust valves with an offset, for example, of 80° crankshaft angle. The latter movement is completed as conventionally known when the piston reaches the top dead center in the cylinder.

In the second part of the cycle, the exhaust valves are kept closed while the two intake valves are opened then closed to conduct intake in a conventional manner, and with a normal amplitude on this occasion Precisely, the opening movement of the intake valves is initiated when the piston has reached the top dead center.

In consequence during an engine cycle as illustrated in FIG. 2, each intake valve is opened twice and each exhaust valve is opened once Furthermore, the two successive openings of each intake valve have different amplitudes from one another, the amplitude being lower during the exhaust and during the intake.

With reference to FIG. 2, the embodiment corresponding to configuration 2 will now be described.

This time, in addition to the normal cycle at the exhaust and intake, the exhaust valves are opened while intake occurs with the intake valves.

More precisely, the cycle takes place as follows The intake valves are first kept closed (curve 1) while the exhaust valves are opened then closed (curve 2) to carry out exhaust conventionally. Exhaust is completed by the closure of the exhaust valves when the piston reaches the top dead center. At this moment, the opening movement of the intake valves is initiated and then, after a period corresponding for example to about 60° crankshaft angle, an opening movement of the exhaust valves is initiated. In consequence, during a certain period, the opening movements of the exhaust and intake valves take place simultaneously. The intake valves have reached the end of their trajectory before the exhaust valves complete their movement. In consequence, the closure movement of the intake valves is initiated while the opening movement of the exhaust valves is not yet completed. Once the latter movement is completed, the situation stands at a point of the cycle in which the closure movements of the exhaust and intake valves are carried out simultaneously. Since the trajectory of the exhaust valves is not as long as the trajectory of the intake valves at this place of the cycle, the cycle is arranged so that the two closure movements are completed at the same time. Furthermore, the amplitude of movement of the exhaust valves during the actuation of the intake valves is lower than their amplitude during the normal exhaust phase.

It is observed in consequence that, during this cycle, each exhaust valve is opened twice and each intake valve is opened once. Furthermore, the two successive openings of each exhaust valve have different amplitudes from one another, the amplitude being higher during intake than during exhaust.

Distributors 12 and 16 for implementing these control laws can be prepared easily from the distributors of the prior art.

In configuration 1, the opening of the two intake valves during the exhaust phase makes it possible to store part of the burnt gases in the intake plenum before being reintroduced into the cylinders during the next intake. This short loop of the EGR gases serves to introduce hotter burnt gases than in the case of a conventional circuit.

In configuration 2, in which the two exhaust valves are opened during the intake phase the hot burnt gases are introduced at the same time as the fresh air into the cylinder. In this configuration the burnt gases are particularly hot.

Each of these two strategies allows a substantial reduction of the unburnt emissions without increasing fuel consumption.

Tn fact, if configuration 1 is considered with an optimized valve lift law and spread in the operating point at 1500 revolutions per minute of the engine and 10⁵ Pa of TDC, the method allows a reduction of hydrocarbon emissions by 40% and without extra consumption of fuel as shown in FIG. 3. In this configuration, there is no increase in the exhaust temperature as shown in FIG. 4. Contrary to configuration 2, there is practically no loss of engine filling with regard to a standard law, the internal EGR gases being colder.

In the case of configuration 2, if the same point of 1500 revolutions per minute with 10⁵ Pa of TDC is considered, a hydrocarbon emission reduction of 70% is also obtained here without extra fuel consumption. An increase in the exhaust temperature of about 35° C. is also observed, as shown in FIG. 4. This increase is due to the loss of engine filling with regard to a standard law. The opening of the exhaust valves during the intake phase causes the filling of the cylinder with hot (lower density) burnt gases which occupy more space than the same mass of external EGR.

Configuration 2 allows a greater reduction of unburnt emissions and an increase in the exhaust temperature. Although it appears more advantageous, configuration 1 is also advantageous.

This invention can be implemented on all engines, regardless of the number of valves per cylinder (one or two exhaust valves, one or two intake valves) and regardless of the pattern of the valves, whether valves at 0° or 90°.

It is observed that, in configuration 1, the intake valves being open during the exhaust phase, part of the burnt gases is stored in the intake plenum before being reintroduced into the cylinder during the next intake. This short loop of the EGR gases serves to introduce hotter burnt gases than in the case of a conventional circuit.

In configuration 2, for which the two exhaust valves are open during the intake, the hot burnt gases are introduced at the same time as the fresh air. Accordingly the burnt gases are very hot.

These two strategies have many advantages. They are particularly suitable for diesel engines. The simultaneous opening of the exhaust and intake valves serves to sharply increase the quantity of internal EGR without causing impact between the valves and the piston. Moreover, there is no extra fuel consumption. The simultaneous opening of the exhaust and intake valves has no impact on the negative loop of the BDC.

The invention is suitable for increasing the quantity of internal EGR gases without increasing fuel consumption on the low load operating points of the engine or when the engine is cold. On the medium and highly loaded operating points, it is the external EGR circuit that supplies the engine with sharply cooled burnt gases. In fact, on these operating points, it is chiefly the NOx emissions which must be reduced, the unburnt emissions being lower and the oxidation catalyst being initiated.

Obviously, many changes can be made to the invention without extending beyond its scope. Thus, numerous alternatives can be made to the configurations 1 and 2.

In the first, the opening of the intake valves could be initiated after the opening movement of the exhaust valves has began. Similarly, the valves could all be closed at the same time. Their trajectories could also be made to have the same distance.

In configuration 2, the closure movement of the exhaust valves could be completed before the complete closure of the intake valves. Similarly, the opening movements of the exhaust and intake valves could be initiated simultaneously. The same span could also be given to their trajectory.

1-16. (canceled)

17. A method for controlling a vehicle engine, comprising:
imparting, in an exhaust phase, an opening movement to at least one intake valve while imparting an opening movement to at least one exhaust valve associated with a same cylinder as the intake valve, and
wherein the two opening movements are initiated at a same time.

18. The method as claimed in claim 17, wherein the two opening movements have different amplitudes.

19. The method as claimed in claim 17, wherein a closure movement is imparted to the intake valve while a closure movement is imparted to the exhaust valve.

20. A method for controlling a vehicle engine, comprising:
imparting, in an intake phase, a closure movement to at least one intake valve while imparting a closure movement to at least one exhaust valve associated with a same cylinder as the intake valve, and
wherein the two closure movements are initiated at a same time.

21. The method as claimed in claim 20, wherein the two closure movements have different amplitudes.

22. The method as claimed in claim 20, wherein an opening movement is imparted to the intake valve while an opening movement is imparted to the exhaust valve.

23. The method as claimed in claim 17, wherein the exhaust valve is kept closed for a period, and during the period the intake valve is opened and then closed.

24. The method as claimed in claim 17, wherein, during an engine cycle, the intake valve is opened twice and the exhaust valve is opened once.

25. The method as claimed in claim 24, wherein the two openings of the intake valve have different amplitudes.

26. The method as claimed in claim 20, wherein the intake valve is kept closed for a period, and during the period the exhaust valve is opened and then closed.

27. The method as claimed in claim 20, wherein, during an engine cycle, the exhaust valve is opened twice and the intake valve is opened once.

28. The method as claimed in claim 27, wherein the two openings of the exhaust valve have different amplitudes.

29. The method as claimed in claim 17, only implemented when an engine load is lower than a predefined value.

30. The method as claimed in claim 17, wherein the engine is a direct injection diesel engine.

31. A vehicle engine comprising:
at least one cylinder;
intake and exhaust valves associated with the cylinder; and
controlled means configured to impart an opening movement to the intake valve while imparting an opening movement to the exhaust valve and to initiate the two opening movements at a same time.

32. A vehicle engine comprising:
at least one cylinder;
intake and exhaust valves associated with the cylinder; and
controlled means configured to impart a closure movement to the intake valve while imparting a closure movement to the exhaust valve and to complete the two closure movements at a same time.
